(19) United States
(12) Patent Application Publication
(10) Pub. No.: US 2025/0212898 A1
(43) Pub. Date: Jul. 3, 2025

(54) Cookie-Cutting Device

(71) Applicant: Tyler Pagley, Youngstown, OH (US)

(72) Inventor: Tyler Pagley, Youngstown, OH (US)

(21) Appl. No.: 18/985,784

(22) Filed: Dec. 18, 2024

Related U.S. Application Data
(60) Provisional application No. 63/612,054, filed on Dec. 19, 2023.

(51) Int. Cl. A21C 11/10

(52) U.S. Cl. CPC A21C 11/106

(57) ABSTRACT

A cookie-cutting device is provided. The device is comprised of a cookie-cutting device designed to streamline the production of cream wafer cookies by cutting, shaping, and perforating dough in a single motion. The device comprises at least one cookie-cutting member with a continuous sidewall featuring notches for creating jagged edges or smooth options for plain edges. The bottom surface of the cutting member includes pointed members to perforate the dough, enabling customizable decorative patterns. Multiple cookie-cutting members can be arranged in various patterns to cut several cookies simultaneously, enhancing efficiency and reducing waste. The method of use involves pressing the device onto dough to simultaneously cut and perforate, simplifying and accelerating cookie production compared to manual techniques.

### CROSS-REFERENCE TO RELATED APPLICATION

The present application claims priority to, and the benefit of, U.S. Provisional Application No. 63/612,054, which was filed on Dec. 19, 2023, and is incorporated herein by reference in its entirety.

### FIELD OF THE INVENTION

The present invention relates generally to the field of cooking cutting and forming devices. More specifically, the present invention relates to a cookie-cutting device that efficiently cuts, shapes, and perforates dough in a single motion into cream wafer cookies. Accordingly, the present disclosure makes specific reference thereto. Nonetheless, it is to be appreciated that aspects of the present invention are also equally applicable to other like applications, devices, and methods of manufacture.

### BACKGROUND

The preparation of cream wafer cookies involves a meticulous and time-consuming process that demands precision and consistency. Traditional methods require bakers to manually cut out individual cookies, create notched edges, and add a series of perforations to the top surface. This manual approach significantly increases the production time and labor required, making it challenging to produce large quantities efficiently. The notched edges and perforations are important not only for the cookie's signature aesthetic but also for controlling texture and baking consistency. As demand for these cookies grows in both commercial and home baking environments, the need for a streamlined process becomes more apparent. Inconsistent hand-cutting techniques often lead to variations in cookie size, shape, and structural integrity, negatively impacting the final product. Furthermore, repetitive hand motions can result in strain and fatigue for the user, diminishing productivity. The lack of standardized tools to simplify the cutting and shaping process has posed a long-standing challenge for bakers. Therefore, addressing these inefficiencies is essential to improve the consistency and efficiency of cream wafer cookie production.

Therefore, there exists a long-felt need in the art for a cookie-cutting device that allows a user to easily cut and shape cookies. There also exists a long-felt need in the art for a cookie-cutting device that allows a user to simultaneously cut and form cream wafer cookies. Moreover, there exists a long-felt need in the art for a device that allows a user to easily cut and shape cream wafer cookies while creating notched cookie edges and a perforated cookie top surface.

The subject matter disclosed and claimed herein, in one embodiment thereof, comprises a cookie-cutting device. The device is comprised of a cookie-cutting device designed to streamline the production of cream wafer cookies by cutting, shaping, and perforating dough in a single motion. The device comprises at least one cookie-cutting member with a continuous sidewall featuring notches for creating jagged edges or smooth options for plain edges. The bottom surface of the cutting member includes pointed members to perforate the dough, enabling customizable decorative patterns. Constructed from durable food-grade materials such as stainless steel, aluminum, plastic, or silicone, the device may also include an ergonomic handle for improved user control. Multiple cookie-cutting members can be arranged in various patterns to cut several cookies simultaneously, enhancing efficiency and reducing waste. This device is adaptable for creating various cookies, including sugar cookies, butter cookies, shortbread, and custom shapes, making it versatile for diverse baking needs. The method of use involves pressing the device onto dough to simultaneously cut and perforate, simplifying and accelerating cookie production compared to manual techniques.

In this manner, the cookie-cutting device of the present invention accomplishes all the forgoing objectives and provides a specialized tool designed for making cream wafer cookies efficiently and consistently. The device includes at least one cookie-cutting member with a continuous sidewall that features a series of notches, allowing the edges of the dough to be shaped uniformly with each use. The downward-pointing members on the bottom surface of the top wall ensure that perforations are simultaneously formed while the cookies are being cut. The inclusion of handles facilitates case of use, enabling bakers to apply consistent pressure and reduce fatigue. Additionally, embodiments with multiple cookie-cutting members arranged in a row-like pattern allow users to cut multiple cookies at once, significantly reducing production time. This device enhances productivity, ensures uniformity in cookie design, and alleviates the physical strain associated with manual cookie preparation.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cookie-cutting device. The invention pertains to a cookie-cutting device designed to efficiently produce cream wafer cookies with notched edges and perforated surfaces in a single motion, improving productivity and reducing manual effort.

The device is constructed from food-grade materials such as stainless steel, aluminum, plastic, or silicone, ensuring durability, ease of cleaning, and corrosion resistance. The design allows for adaptability in cutting various types and shapes of cookies, including cream wafer cookies, sugar cookies, butter cookies, and custom-shaped cookies.

The device comprises at least one cookie-cutting member, typically circular but adaptable to other shapes such as squares, rectangles, or stars. The cookie-cutting member includes a continuous sidewall, which may feature notches for jagged edges or remain smooth for plain-edged cookies. A top wall and a bottom surface are also included, with the bottom surface containing at least one pointed member that perforates the dough to create decorative patterns, including emblems, letters, or logos.

A handle is affixed to the top wall or sidewall to facilitate gripping and applying downward pressure. The handle may have an ergonomic design and a non-slip surface for enhanced control, especially when cutting thick or chilled dough.

In the preferred embodiment, multiple cookie-cutting members are arranged in a row or grid pattern, enabling simultaneous cutting of multiple cookies to increase efficiency and minimize dough waste.

The method of using the device involves positioning it over the dough, pressing down to cut and perforate the cookies in one step, and then lifting the device to separate the formed cookies from the excess dough. This process streamlines cookie production, making it suitable for various types of cookies and customizable designs.

Accordingly, the cookie-cutting device of the present invention is particularly advantageous as it provides a specialized tool designed for making cream wafer cookies efficiently and consistently. The device includes at least one cookie-cutting member with a continuous sidewall that features a series of notches, allowing the edges of the dough to be shaped uniformly with each use. The downward-pointing members on the bottom surface of the top wall ensure that perforations are simultaneously formed while the cookies are being cut. The inclusion of handles facilitates case of use, enabling bakers to apply consistent pressure and reduce fatigue. Additionally, embodiments with multiple cookie-cutting members arranged in a row-like pattern allow users to cut multiple cookies at once, significantly reducing production time. This device enhances productivity, ensures uniformity in cookie design, and alleviates the physical strain associated with manual cookie preparation. In this manner, the cookie-cutting device overcomes the limitations of existing methods of forming cookies, and specifically cream wafer cookies, known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cookie-cutting device of the present invention in accordance with the disclosed architecture;

FIG. 2 illustrates a top view of one potential embodiment of a cookie-cutting device of the present invention in accordance with the disclosed architecture;

FIG. 3 illustrates a bottom view of one potential embodiment of a cookie-cutting device of the present invention in accordance with the disclosed architecture; and

FIG. 4 illustrates a flowchart of a method of using one potential embodiment of a cookie-cutting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cookie-cutting device that allows a user to easily cut and shape cookies. There also exists a long-felt need in the art for a cookie-cutting device that allows a user to simultaneously cut and form cream wafer cookies. Moreover, there exists a long-felt need in the art for a device that allows a user to easily cut and shape cream wafer cookies while creating notched cookie edges and a perforated cookie top surface.

The present invention, in one exemplary embodiment, is comprised of a cookie-cutting device. The invention relates to a cookie-cutting device designed to produce cream wafer cookies with notched edges and perforated surfaces in a single motion, enhancing productivity and minimizing manual effort.

The device is made from food-grade materials, such as stainless steel, aluminum, plastic, or silicone, to ensure durability, easy cleaning, and resistance to corrosion. The design accommodates various types and shapes of cookies, including cream wafer cookies, sugar cookies, butter cookies, and custom shapes.

The device includes at least one cookie-cutting member, typically circular, but adaptable to other shapes such as squares, rectangles, or stars. The cookie-cutting member has a continuous sidewall, which may include notches for jagged edges or remain smooth for plain edges. It also features a top wall and a bottom surface, with at least one pointed member extending from the bottom surface to perforate the dough and create decorative patterns, such as emblems, letters, or logos.

A handle is attached to the top wall or sidewall to assist in gripping and applying downward pressure. The handle may incorporate an ergonomic design and a non-slip surface to improve control, particularly when cutting thick or chilled dough.

In the preferred embodiment, multiple cookie-cutting members are arranged in a row or grid pattern, allowing the simultaneous cutting of multiple cookies, thereby improving efficiency and minimizing dough waste.

The method of using the device involves positioning it over the dough, applying downward pressure to cut and perforate the cookies in one step, and then lifting the device to separate the formed cookies from the excess dough. This process simplifies cookie production and supports various types and customizable designs.

Therefore, the cookie-cutting device of the present invention provides an efficient tool for consistently producing cream wafer cookies. The device includes at least one cookie-cutting member with a continuous sidewall featuring notches for uniform edge shaping. The downward-pointing members on the bottom surface of the top wall create perforations during cutting. The handle allows bakers to apply consistent pressure, reducing fatigue. In addition, embodiments featuring multiple cookie-cutting members in a row-like pattern enable simultaneous cutting of multiple cookies, significantly reducing production time. This device enhances productivity, ensures design uniformity, and alleviates the physical strain of manual cookie preparation, addressing the limitations of existing methods for forming cookies, particularly cream wafer cookies.

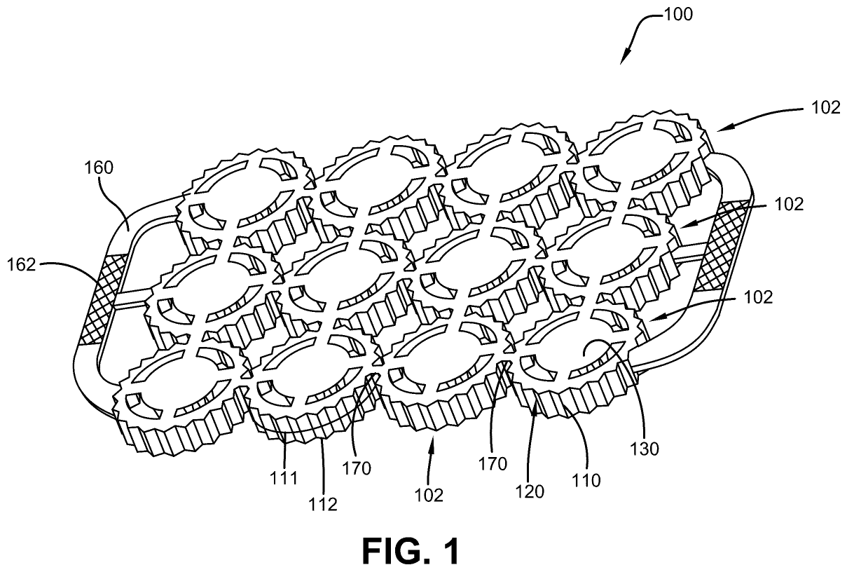

Referring initially to the drawings, FIG. 1 illustrates a perspective view of one potential embodiment of a cookie-cutting device 100 of the present invention in accordance with the disclosed architecture. The invention described herein pertains to a cookie-cutting device 100 designed to facilitate the efficient production of cream wafer cookies. As noted, cream wafer cookies are distinguished by their notched edges and perforated top surfaces, which traditionally require a labor-intensive manual process to create. This invention addresses the need for a device capable of simultaneously cutting and forming these cookies with these specific features in a single motion, thereby improving productivity and reducing effort.

The materials used in constructing the device 100 may include food-grade stainless steel, aluminum, plastic, or silicone, chosen for durability, case of cleaning, and resistance to corrosion. Furthermore, the device 100, and the shape and arrangement of all components of the device 100, is adaptable for cutting and shaping other types of cookies that may or may not require notched edges or perforated surfaces such as but not limited to a cream wafer cookies, sugar cookies, butter cookies, shortbread cookies, gingerbread cookies, Linzer cookies, biscotti dough, holiday cookies, filled cookies, sablé cookies, almond cookies, fortune cookies, rugelach cookies, nuthorn cookies, kiffle cookies, clothespin cookies, perforated cutter cookies, pie cookies, scones, round-shaped cookies, scallop cookies, square-shaped cookies, rectangular-shaped cookies, hexagonal-shaped cookies, star-shaped cookies, heart-shaped cookies, flower-shaped cookies, diamond-shaped cookies, oval-shaped cookies, custom-shaped cookies, tree-shaped cookies, wreath-shaped cookies, bell-shaped cookies, pumpkin-shaped cookies, shamrock-shaped cookies, egg-shaped cookies, snowflake-shaped cookies, football-shaped cookies, maple leaf-shaped cookies, etc.

The device 100 is comprised of at least one cookie-cutting member 102 which can be generally circular in shape, though other geometric shapes such as squares, rectangles, hexagons, or stars may also be used depending upon the type of cookie the device 100 is being used to form. Each cookie-cutting member 100 preferably features a continuous sidewall 110 with a plurality of notches 120 designed to create the jagged edges on the cream wafer cookie. In certain embodiments, the sidewall 110 may be smooth, providing the option to produce cookies with plain edges, depending on user preference or cookie type. In one embodiment, the sidewall 110 is comprised of at least one measurement line 111. The line 111 may be in the form of a color band, a colored line, a marking, etc., wherein the distance from the bottom edge 112 of the sidewall 110 to line 111 (or any portion of the line 111 including but not limited to a top edge of the line 111, a bottom edge of the line 111, etc.) indicates the thickness that dough should be rolled to create the desired cookie using the device 100. For example, in one embodiment, the line 111 is a colored band that is ⅛″ tall from the bottom edge 112 of the sidewall 110, wherein ⅛″ is the thickness that cream wafer dough should be rolled to before pressing the dough with the device 100. The color of the line 111 is preferably a different color than the remainder of the device 100.

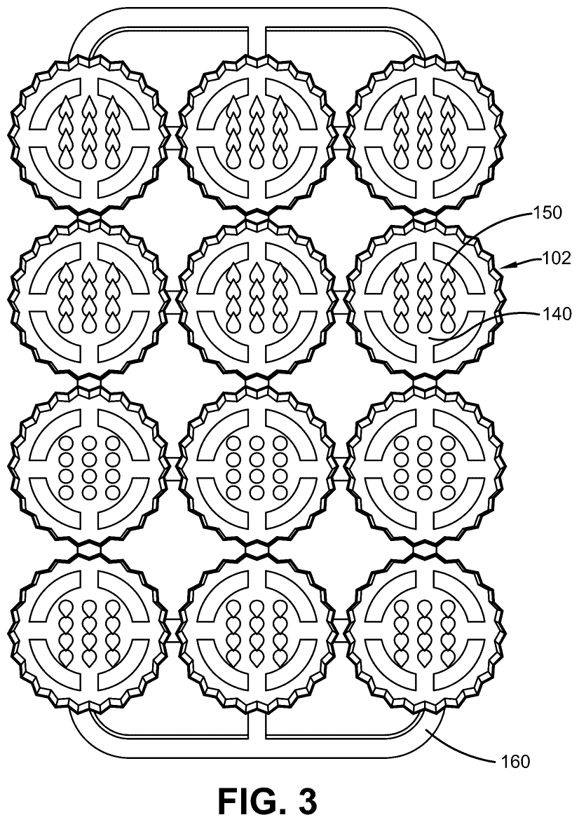

The cookie cutting member 102 may be comprised of a top wall 130 and a bottom surface 140. The bottom surface 140 may include at least one pointed member 150 extending downward away from the bottom surface 140, as seen in FIG. 3. These pointed members 150 are designed to form perforations on the top surface of the dough to form the top shape of a cream wafer cookie. The pointed members 150 can vary in length, shape, and arrangement, allowing for customization of the perforation pattern. This allows the member 150 form any type of decorative pattern that can be cut or stamped into a cookie such as but not limited to an emblem, a letter, a number, a logo, an image, etc. This feature allows the user to produce cookies with varying degrees of decoration or aeration, which can be essential for specific recipes. In some embodiments, the shape of the cookie cutting member 102 does not necessitate the use of a top wall 130.

The device 100 may also include a handle 160, which is affixed to the top wall 130 and/or sidewall 110 to allow the user to grip and apply downward pressure onto dough while using the device 100. The handle 160 may feature any ergonomic design and a non-slip surface 162 for enhanced control and case of use, particularly when cutting through thick or chilled dough. The surface 162 may be comprised of a texture such as but not limited to a raise and/or recessed texture.

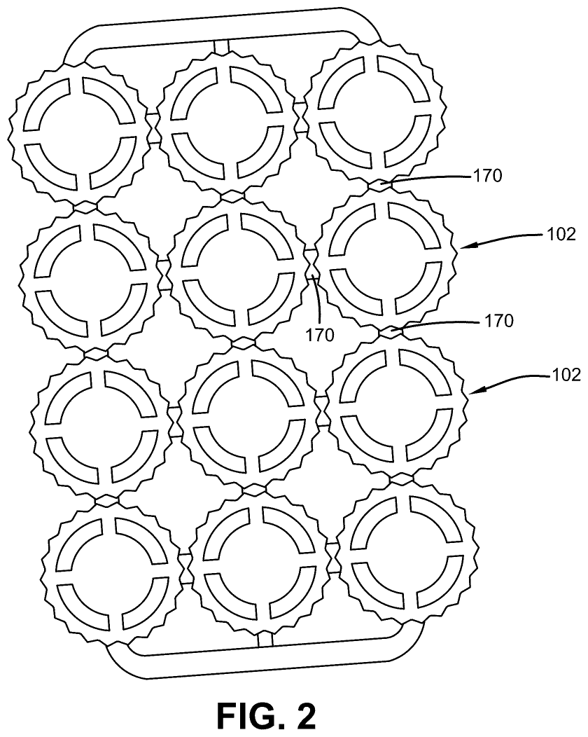

In the preferred embodiment, the device 100 includes multiple cookie-cutting members 102 attached to one another (via at least one spacer member 170, as seen in FIG. 1 and FIG. 2) and arranged in a row-like pattern, as seen in. This configuration allows the user to cut and form multiple cookies simultaneously, significantly increasing efficiency compared to cutting one cookie at a time. The spacing and arrangement of the cookie-cutting members 100 can vary, with options for grid patterns, staggered rows, or customized layouts to optimize dough usage and minimize waste

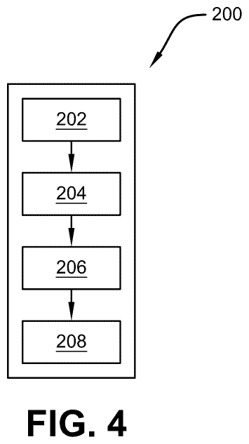

The present invention is also comprised of a method of using 200 the cookie-cutting device 100, as seen in FIG. 4. First, a cookie-cutting device 100 is provided, which is comprised of a body that includes at least one cookie-cutting member 102 and at least one handle 160 [Step 202]. Next, the user positions the device 100 over a sheet of dough, ensuring that the cutting members 100 are aligned according to the desired cutting pattern [Step 204]. The user then applies downward pressure by gripping the handle 160 and pressing the device 100 firmly onto the dough [Step 206]. As the device 100 is pressed down, the sidewalls 110 of the cutting members 100 cut through the dough, creating individual pieces with notched or smooth edges. Simultaneously, the pointed members 150 on the bottom surface 140 of the top wall 130 perforate the dough, forming a series of holes on the top surface of each cookie, if desired. Once the cookies are cut and, if applicable, perforated, the user lifts the device 100 to separate the formed dough pieces from the surrounding excess dough [Step 208].

The device 100 streamlines the process of producing cream wafer cookies by combining cutting, shaping, and perforating into a single step. The ability to cut multiple cookies simultaneously further enhances efficiency and reduces the time and effort required compared to traditional manual methods. Additionally, the device 100 can be used in the same fashion to produce other types of cookies, including sugar cookies, butter cookies, shortbread cookies, and decorative holiday cookies. The customizable features, such as the shape of the sidewalls and the arrangement of the pointed members, allow for a wide variety of designs to be achieved.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cookie-cutting device” and “device” are interchangeable and refer to the cookie-cutting device 100 of the present invention.

Notwithstanding the forgoing, the cookie-cutting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cookie-cutting device 100 as shown in the FIGS. are for illustrative purposes only, and that many other sizes and shapes of the cookie-cutting device 100 are well within the scope of the present disclosure. Although the dimensions of the cookie-cutting device 100 are important design parameters for user convenience, the cookie-cutting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cookie-cutting device comprising:
a first cookie-cutting member having a continuous sidewall, the continuous sidewall comprising a notch configured to form a jagged edge and a measurement line;
a top wall connected to the sidewall, the top wall comprised of a bottom surface;
a pointed member extending downward from the bottom surface, the pointed member configured to form a perforation on a top surface of a dough; and
a handle configured to allow a user to apply downward pressure onto the dough.

2. The cookie-cutting device of claim 1, wherein the handle attaches to the top wall.

3. The cookie-cutting device of claim 1, wherein the handle attaches to the continuous sidewall.

4. The cookie-cutting device of claim 1, wherein the first cookie-cutting member is circular in shape.

5. The cookie-cutting device of claim 1, wherein the pointed member comprises a plurality of pointed members arranged in a pattern to form a decorative perforation.

6. The cookie-cutting device of claim 1, wherein the decorative perforation is comprised of an emblem, a letter, a number, a logo, or an image.

7. The cookie-cutting device of claim 1, wherein the handle is comprised of a non-slip surface comprised of a texture.

8. The cookie-cutting device of claim 1 further comprised of a second cookie cutting member.

9. The cookie-cutting device of claim 8, wherein the first cookie cutting member and the second cookie cutting member are arranged in a row.

10. The cookie-cutting device of claim 8, wherein the first cookie cutting member and the second cookie cutting member are arranged in a grid.

11. A cookie-cutting device comprising:
a first cookie-cutting member having a continuous sidewall;
a top wall connected to the sidewall, the top wall comprised of a bottom surface; and
a handle configured to allow a user to apply downward pressure onto a dough.

12. The cookie-cutting device of claim 11 further comprised of a pointed member extending downward from the bottom surface, the pointed member configured to form a perforation on a top surface of a dough.

13. The cookie-cutting device of claim 11, wherein the continuous sidewall is smooth.

14. The cookie-cutting device of claim 11, wherein the cookie-cutting member is comprised of a round shape, a square shape, a rectangular shape, a hexagonal shape, a star shape, a heart shape, a flower shape, a diamond shape, an oval shape, or a custom shape.

15. The cookie-cutting device of claim 11 further comprised of a second cookie cutting member.

16. The cookie-cutting device of claim 15, wherein the first cookie cutting member and the second cookie cutting member are arranged in a row.

17. The cookie-cutting device of claim 15, wherein the first cookie cutting member and the second cookie-cutting member are arranged in a grid.

18. A method of using a cookie-cutting device, the method comprising the following steps:
providing a cookie-cutting device comprised of a handle, and a cookie-cutting member with a sidewall, a top wall connected to the sidewall, a bottom surface of the top wall, and a pointed member extending downward from the bottom surface;
positioning the cookie-cutting device over a dough such that the cookie-cutting member aligns with a desired cutting pattern; and
applying downward pressure on the handle to press the cookie-cutting member into the dough, wherein the sidewall of the cookie-cutting member cuts through the dough to form an individual cream wafer cookie shape.

19. The method of using a cookie-cutting device of claim 18, wherein the sidewall is comprised of a notch.

20. The method of using a cookie-cutting device of claim 18, wherein the handle is comprised of a textured handle.
